(19) United States
(12) Patent Application Publication
(10) Pub. No.: US 2011/0151110 A1
(43) Pub. Date: Jun. 23, 2011

(54) METAL NANOPARTICLE INK COMPOSITIONS

(76) Inventor: Frank St. John, Rockford, IL (US)

(21) Appl. No.: 13/055,858

(22) PCT Filed: Jul. 23, 2009
(86) PCT No.: PCT/US09/51543

§ 371 Date: Mar. 7, 2011

Related U.S. Application Data
(60) Provisional application No. 61/083,626, filed on Jul. 25, 2008.

(51) Int. Cl. B05D 5/12; C09D 11/00; B05D 5/04; B05D 1/00; B05D 1/02; B05D 1/28; B82Y 30/00

(52) U.S. Cl. 427/58; 106/31.92; 977/773

(57) ABSTRACT

Nanoparticle inks which do not require further processing steps after application to a substrate in order to form a conductive or decorative pattern are described. The nanoparticle inks contain metal nanoparticles, one or more humectants, a dispersant and a solvent. Methods for forming the nanoparticle inks include a low energy mixing step and a high energy mixing step in order to form nanoparticle inks with the desired properties. Also described are cartridges comprising the nanoparticle inks which can be installed in standard printers.

This application claims the priority of U.S. Provisional Patent Application Ser. No. 61/083,626, filed Jul. 25, 2009, which is incorporated herein by reference.

### FIELD OF THE INVENTION

The present invention relates to printable nanoparticle inks that can be used to form electrically conductive or decorative layers and patterns on a substrate. More particularly, the present invention relates to printable nanoparticle inks containing metal nanoparticles that do not require additional sintering steps after printing in order to form a sintered pattern.

### BACKGROUND OF THE INVENTION

Ink compositions containing metal particles are useful for the fast and efficient printing of conductive patterns. Previously known conductive ink compositions have required post printing heat treatment in order to sinter the printed pattern so that it becomes conductive. Such post printing heat treatment increases production time and costs. Further, many substrates, such as polymer substrates, may not be amenable to heat treatment as they begin to melt or degrade at the temperatures necessary for ink sintering.

U.S. Pat. No. 7,316,475 to Cornell et al. describes an aqueous inkjet ink with silver nanoparticles that can be used to form electrically conductive patterns after sintering by heat.

U.S. Published Patent Application 2006/0163744 to Vanheusden et al. describes a printable electric conductor having metallic nanoparticles in a liquid vehicle. After printing, the liquid vehicle must be removed from the printed pattern in order to make the pattern conductive. The pattern may also be sintered to further improve conductivity.

U.S. Published Patent Application 2006/0130700 to Reinartz describes an inkjet ink containing a silver salt. After printing, the silver ions in the salt must be reduced either through the application of heat or by treatment of the printed pattern with a reducing agent.

U.S. Published Patent Application 2005/0136638 to Voss-Kehl et al. describes an ink composition having silver and gold nanoparticles which must be sintered after printing to form a conductive pattern.

U.S. Published Patent Application 2008/0113195 to Boll et al. describes an aqueous ink containing silver particles. The printed pattern must be sintered in order to make the ink conductive.

As such, there remains a need in the art for inks that do not require extensive post-print processing steps in order to form sintered patterns. Further, there remains a need in the art for inks that form patterns that conduct as well or better than those patterns that have been sintered by heat treatment, without the need for heat treatment.

### SUMMARY OF THE INVENTION

It is an object of the present invention to provide nanoparticle inks suitable for printing on a substrate that do not require additional post-print processing steps in order to form an electrically conductive or decorative pattern. The nanoparticle inks of the present invention comprise metallic nanoparticles, one or more humectants, a dispersant and a solvent.

It is a further object of the present invention to provide methods for making nanoparticle inks that do not require post-print processing. The methods of the present invention combine both high energy and low energy mixing steps along with sieving and filtering steps to form nanoparticle inks with the desired properties.

It is a still further object of the present invention to provide cartridges for use with standard printers. The cartridges of the present invention contain a nanoparticle ink and are manufactured so that they can be installed in a printer in the same manner as an ink cartridge containing standard printing ink.

### DETAILED DESCRIPTION OF THE INVENTION

The present invention contemplates nanoparticle inks and methods for making nanoparticle inks. The nanoparticle inks of the present invention may be used for printing or otherwise applying conductive patterns or layers to substrates. The nanoparticle inks may be applied using an inkjet printing method but may also be applied using other techniques well known in the art. The present invention also contemplates inkjet printer cartridges containing nanoparticle inks.

The present invention further contemplates use of the nanoparticle inks for application of non-conductive patterns, such as decorative patterns. These decorative patterns can be formed in the same manner as a conductive pattern, however, they do not necessarily have to be conductive after the formation of the pattern. As the nanoparticle inks contain metal nanoparticles, the printed decorative patterns tend to a have a shiny metal appearance depending on the metal nanoparticles present in the ink. Depending on the substrate, an ink receptive coating may enable or enhance the shininess of the silver printed on top of it.

The nanoparticle inks of the present invention comprise at least one type of metal nanoparticles that provides the conductivity of the ink. In certain embodiments of the present invention, the metal nanoparticles are silver metal nanoparticles. However, it is also contemplated that the metal nanoparticles may comprise another metal, such as, gold, copper, nickel, cobalt, tin, zinc and other metals having suitable conductive properties. It is also contemplated that more than one type of metal nanoparticle may be used in the same ink composition.

The metal nanoparticles of the present invention are typically provided as a slurry in a suitable slurry solvent. The slurries provided typically contain from about 50% to about 95% by weight nanoparticles, preferably about 75% to about 90% by weight nanoparticles. In certain embodiments, the slurry solvent is isopropol alcohol, although other slurry solvents are contemplated, such as water, simple alcohols and other suitable solvents. The metal nanoparticle slurry should be present in an amount of about 5% to about 45% by weight of the final ink composition.

The nanoparticle inks of the present invention also comprise humectants which prevent the ink from clogging the inkjets and further act as viscosity modifiers. One or more than one humectant may be used in the same ink composition. In certain embodiments of the present invention, the humectants are polyethylene glycol and/or glycerol. However, it is also contemplated that other humectants may be used in forming the inks of the present invention, including polyols like sorbitol, xylitol and maltitol, or polymeric polyols like polydextrose or natural extracts like quillaia, or lactic acid or urea. Typically, the humectant or mixture of humectants is present at a concentration of between about 2% and about 30% by weight of the final ink composition, preferably between about 10% and about 25% by weight of the final ink composition.

The nanoparticle inks of the present invention also comprise dispersants which help prevent flocculation or agglomeration of the metal nanoparticles. Dispersants well known in the art may be used in forming the inks of the present invention. In certain embodiments of the invention, the dispersant is DISPEX A40 from Ciba Specialty Chemicals, Inc. of Basel, Switzerland. It is also contemplated that other dispersants, such as other types of acrylic dispersants may be used in forming the ink compositions of the present invention. Typically, the dispersant or mixture of dispersants will be present at a concentration of between about 0.1% and about 2.0% by weight of the final ink composition.

The balance of the conductive ink will be made up of a solvent. Typically, the solvent will be water suitable for ink compositions. However, it is possible that other solvents which are typically used in forming ink compositions may also be used. This includes solvents that may not be suitable for thermal inkjet printing, e.g. a solvent that is suitable for an ink to be used in a piezo type machine.

The inks of the present invention may also optionally comprise additional components. Examples of such additional components include wetting agents which would allow for the ink to be printed on a wide variety of substrates. In certain embodiments, the wetting agent is Dow Corning 67 Additive, made by Dow Corning of Midland, Mich.

The nanoparticle inks of the present invention are typically formulated to have a viscosity of between about 1 and 100 cP, preferably between about 3 to about 10 cP. The viscosity of the ink compositions can be adjusted by varying the concentrations of the humectant, solvent and nanoparticles as is well known in the art.

The nanoparticle inks of the present invention may be formed by the following method:

A slurry of metal nanoparticles and humectants are mixed by a low energy process until well combined. Mixing may be done by hand or by a low energy planetary mixer such as those made by Hobart Corporation of Troy, Ohio or Littleford Day, Inc. of Florence, Ky. The dispersant is then added to the mixture. The mixture is then passed through a three roll mill several times until a smooth texture is achieved. In certain cases, the dispersion of the mixture may be tested using a Finess of Grind gauge, such as those sold by Precision Gauge and Tool of Dayton, Ohio. Typically, the mixture will be passed through the three roll mill between 1 and 10 times until a desired result is achieved. Examples of three roll mills suitable for use include those sold by Keith Machinery of Lindenhurst, N.Y. The mixture is then sieved through a stainless steel 325 mesh screen.

The resultant material is weighed and proper amount of additional humectant and solvent is added and mixed by hand or with a low shear mixture until well combined. The resultant ink is filtered through a 1 micron filter, such as those manufactured by Pall Corporation of East Hills, N.Y.

In general, the nanoparticle inks of the present invention are made by a process that combines both high energy and low energy mixers in combination with sieving and filtering as described in the above steps.

After the nanoparticle inks of the present invention are formed, they are ready for application to a substrate. Typically, this can be done by filling a print cartridge compatible with the printer to be used for application of the ink. However, it is also contemplated that the ink can be applied to the substrate using other methods, such as brushing or spraying the ink on the substrate.

If a printer, such as an inkjet printer is to be used, the print cartridge containing the conductive ink is installed into the printer. The printer is then programmed to print the desired pattern onto the substrate. Because the nanoparticle inks can be inserted into a variety of print cartridges, the nanoparticle inks can be applied using standard inkjet and medium or large format printers.

A variety of substrates can be used for application of the nanoparticle inks of the present invention. Substrates which can be used with the present invention include paper substrates, such as standard office papers, cardstocks, and photo papers; rigid substrates such as glass, ceramic, wood and FR4 circuit boards; and polymer substrates known in the art as substrates for electrical circuits. An ink receptive coating on the substrate may be used to enable or enhance the shininess of the ink printed on top of the substrate. This ink receptive coating can contain 10% to 75% (by weight of the total ink receptive coating) titania powder, about 0.1% to 10% (by weight of the total ink receptive coating) of a resin, either dissolved or in an emulsion or dispersion, and a liquid such as water or an ester or alcohol solvent. The resin may be, but is not limited to, acrylic resin (e.g. Joncryl 62 from BASF, Florham Park, N.J. 07932, or Paraloid F-10 from Rohm & Haas Co.) or poly vinyl alcohol resin. The alcohol solvent may be, but is not limited to, tridecal alcohol or isopropyl alcohol. The ester solvent may be, but is not limited to, glycol ether EM acetate (2-methoxyethyl acetate) or glycol ether DE acetate (2-(2-ethoxyethoxy)ethyl acetate). The coating may be applied to the substrate by printing, spraying, roller coating, etc., prior to the application of the nanoparticle ink.

After the nanoparticle ink is applied to the substrate, the pattern formed should be conductive and ready for use within seconds of the printing process. In most cases, the printed patterns are usable within the amount of time that it would take for standard ink to dry after printing.

The nanoparticle inks of the present invention require no further processing steps after printing, and the printed patterns are conductive and ready for use upon printing. Without wishing to be bound by theory, it appears that the metal nanoparticles in the nanoparticle inks of the present invention are capable of sintering at room temperature or at temperatures associated with the printing process. As such, the nanoparticle inks of the present invention are capable of forming printed patterns with as good or better conductive properties as inks that require post-print processing steps such as heat sintering.

The present invention also contemplates print cartridges filled with the nanoparticle inks of the present invention. The print cartridges of the present invention will be structured like those known in the art so that they are compatible with the printer with which the ink is to be used. It is contemplated by the present invention that the nanoparticle inks can be used in other types of printers besides inkjet printers, including medium and large format printers and piezo type printers.

Without further description, it is believed that one of ordinary skill in the art can, using the preceding description and the following illustrative example, make and utilize the compounds of the present invention and practice the claimed methods. The following example is given to illustrate the present invention. It should be understood that the invention is not to be limited to the specific conditions or details described in this example.

### Example

A conductive ink was formed having the final formulation:

| | Percent by weight |
|---|---|
| Nanoparticle silver powder slurry | 20% |
| (90% in isopropyl alcohol) | |
| Polyethylene glycol | 13% |
| Glycerol | 5% |
| Dispersant - Ciba DISPEX A40 | 0.5% |
| Deionized water | 61.5% |

The nanoparticle silver slurry, glycerol and part of the polyethylene glycol were hand mixed until well combined. The dispersant was added. The mixture was then passed through a three roll mixer four times until a smooth texture was achieved. The mixed material was sieved through a stainless steel 325 mesh screen. The resultant material was weighed and the proper amount of water and polyethylene glycol to achieve the desired final concentrations was added and mixed by hand. The resultant ink was filtered through a 1 micron filter and was ready for use.

After inkjet printing onto photo paper, the printed pattern had a shiny appearance. Microscopic examination of the print suggested that the silver particles appear to have sintered together without the application of a sintering step after printing.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A nanoparticle ink composition comprising:
metal nanoparticles;
a humectant or mixture of humectants;
a dispersant; and
a solvent making up the balance of the weight of the composition.

2. The nanoparticle ink composition of claim 1, wherein the metal nanoparticles are silver nanoparticles.

3. The nanoparticle ink composition of claim 1, wherein the metal nanoparticles comprise a metal selected from the group consisting of: gold, copper, nickel, cobalt, tin, and zinc or mixtures thereof with or without silver.

4. The nanoparticle ink composition of claim 1, wherein the humectant is selected from the group consisting of: polyethylene glycol, glycerol and mixtures thereof.

5. The nanoparticle ink composition of claim 1, wherein the dispersant is Ciba DISPEX A40.

6. The nanoparticle ink composition of claim 1, wherein the solvent is water.

7. The nanoparticle ink composition of claim 1, wherein the metal nanoparticles is present at a concentration of about 5% to about 45% by weight of the final composition.

8. The nanoparticle ink composition of claim 1, wherein the humectant or mixture of humectants is present at a concentration of about 2% to about 30% by weight of the final composition.

9. The nanoparticle ink composition of claim 1, wherein the dispersant is present at a concentration of about 0.1% to about 2.0% by weight of the final composition

10. A process for forming a nanoparticle ink composition comprising:
providing metal nanoparticles and one or more humectants;
mixing the metal nanoparticles and humectants by a low energy mixing process;
providing a dispersant;
mixing the mixture by a high energy mixing process;
sieving the mixture through a screen;
adding additional humectant and a solvent in amounts sufficient to give the desired final concentration of the components of the composition;
mixing the mixture using a low energy mixing process; and
filtering the resultant mixture to obtain a nanoparticle ink composition.

11. The process of claim 10, wherein the high energy mixing process comprises passing the mixture through a three roll mill.

12. A cartridge for installation in a printer, wherein the cartridge comprises the nanoparticle ink of claim 1.

13. A process for forming a conductive pattern on a substrate, comprising:
providing the nanoparticle ink of claim 1;
providing a substrate; and
applying the nanoparticle ink to the substrate using an application process in a pattern;
wherein the pattern is electrically conductive upon application to the substrate without the need for further processing steps.

14. The process of claim 13, wherein the application process is a printing process.

15. The process of claim 14, wherein the printing process is an inkjet printing process.

16. The process of claim 13, further comprising coating the substrate with an ink receptive coating.

17. The process of claim 16, wherein the ink receptive coating contains about 10% to 75% (by weight of the total ink receptive coating) titania powder and about 0.1% to 10% (by weight of the total ink receptive coating) of a resin either dissolved in a liquid or in an emulsion or dispersion in a liquid.

18. The process of claim 17, wherein the liquid is water or and ester or alcohol solvent.

19. The process of claim 17, wherein the resin is acrylic resin or polyvinyl alcohol resin.

20. The process of claim 16, wherein the coating process is applied to the substrate by printing, spraying, or roller coating.
